(19) United States
(12) Patent Application Publication
(10) Pub. No.: US 2026/0119425 A1
(43) Pub. Date: Apr. 30, 2026

(54) INCREASED DECISION FEEDBACK EQUALIZATION ACCURACY BASED ON DIVIDED DATA STROBE CONTROL

(71) Applicant: Micron Technology, Inc., Boise, ID (US)

(72) Inventor: Mijo Kim, Boise, ID (US)

(21) Appl. No.: 19/347,509

(22) Filed: Oct. 1, 2025

Related U.S. Application Data
(60) Provisional application No. 63/712,961, filed on Oct. 28, 2024.

(51) Int. Cl. G06F 13/28; G06F 13/16

(52) U.S. Cl. CPC G06F 13/28; G06F 13/1689

(57) ABSTRACT

Methods, systems, and devices for increased decision feedback equalization (DFE) accuracy based on divided data strobe control are described. A memory system may receive write commands to write a first burst of data and a second burst of data. Additionally, the memory system may receive a first data strobe signal associated with the write commands that has a duration between communication of the first burst of data and the second burst of data. Upon receiving the first data strobe signal, the memory system may generate a set of second data strobe signals that are phase-shifted relative to each other and are used to latch the first burst of data and the second burst of data. Additionally, the memory system may deactivate a second data strobe signal of the set of second data strobe signals during the duration and after the first burst of data is received.

### CROSS REFERENCE

The present Application for Patent claims priority to U.S. Patent Application No. 63/712,961 by Kim entitled “INCREASED DECISION FEEDBACK EQUALIZATION ACCURACY BASED ON DIVIDED DATA STROBE CONTROL,” filed October 28, 2024, which is assigned to the assignee hereof, and which is expressly incorporated by reference in its entirety herein.

### TECHNICAL FIELD

The following relates to one or more systems for memory, including increased decision feedback equalization (DFE) accuracy based on divided data strobe control.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports increased decision feedback equalization (DFE) accuracy based on divided data strobe control in accordance with examples as disclosed herein.

FIG. 2 shows an example of a signal timing diagram that supports increased DFE accuracy based on divided data strobe control in accordance with examples as disclosed herein.

FIG. 3A shows an example of a system that supports increased DFE accuracy based on divided data strobe control in accordance with examples as disclosed herein.

FIG. 3B shows an example of a signal timing diagram that supports increased DFE accuracy based on divided data strobe control in accordance with examples as disclosed herein.

FIG. 4 shows a block diagram of a memory system that supports increased DFE accuracy based on divided data strobe control in accordance with examples as disclosed herein.

FIG. 5 shows a flowchart illustrating a method or methods that support increased DFE accuracy based on divided data strobe control in accordance with examples as disclosed herein.

### DETAILED DESCRIPTION

A memory system may receive consecutive write commands and a data strobe signal for the consecutive write commands. In some examples, the data strobe signal may include a gap between a first burst of data and a second burst of data of the consecutive write commands. The memory system may divide the data strobe into multiple phase-shifted data strobes and during the gap, a divided data strobe signal may indicate to latch a last write data bit of the first burst of data and remain in an active state for the duration of the gap.

In some examples, the memory system may utilize a decision feedback equalization (DFE) function to reduce inter-symbol interference (ISI) and perform gain control of a first write bit of the second burst of data using a signal associated with the last write bit of the first burst of data. However, the signal associated with the last write bit of the first burst of data may not be an accurate representation of a current state of the data line causing the memory system to inaccurately apply the DFE function to the first write bit of the second burst of data. In some memory systems, the trigger for deactivating the DFE function may be related to the data strobe signal. In situations where the data strobe signal may not fully reset, the DFE function may still be applied potentially introducing errors into the data.

As described herein, the memory system may deactivate the divided data strobe signal indicating to latch the last write bit of the first burst of data during the gap and prior to an indication to latch the first write bit of the second burst of data. The deactivation may occur during a DFE reset period. In response to the deactivation of the divided data strobe signal, the memory system may reset the DFE function for gain control of the first write bit of the second burst of data such that the DFE function may not rely on the signal associated with the last write bit thereby increasing an accuracy of the DFE function.

In addition to applicability in memory systems as described herein, techniques for increasing DFE accuracy based on divided data strobe control may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing errors in access operations, which may decrease latency or otherwise improve user experience, among other benefits.

Features of the disclosure are illustrated and described in the context of systems and architectures. Features of the disclosure are further illustrated and described in the context of signal timing diagrams and flowcharts.

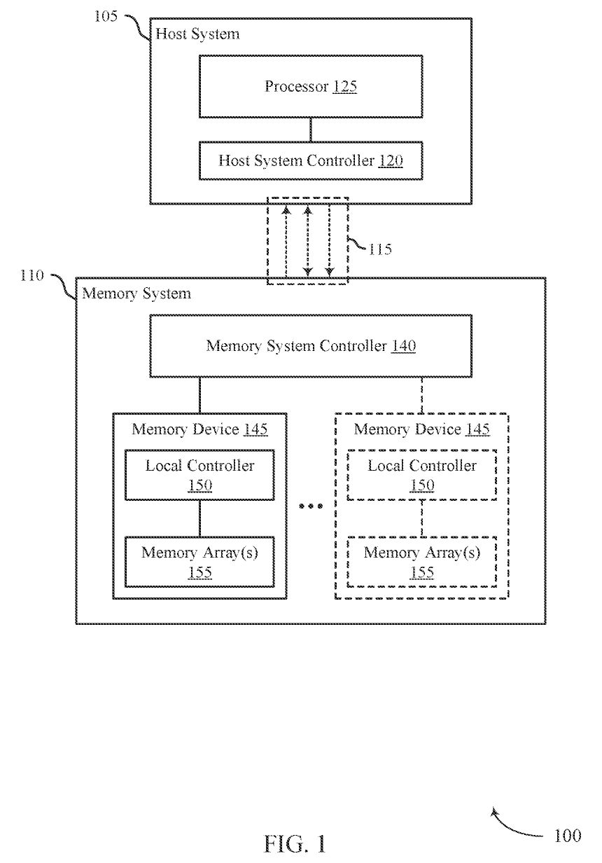

FIG. 1 illustrates an example of a system 100 that supports increased DFE accuracy based on divided data strobe control in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

In some examples, the memory system 110 may receive a first write command to write a first burst of data to the memory system 110 and a second write command to write a second burst of data to the memory system 110. In addition to the first write command and the second write command, the memory system 110 may receive a first data strobe signal associated with the first write command and the second write command. In some examples, the first data strobe may have a duration between communication of the first burst of data and the second burst of data. Upon receiving the first data strobe signal, the memory system 110 may generate a set of second data strobe signals that are phase-shifted relative to each other based on the first data strobe signal. In some examples, the set of second data strobe signals are used to latch the first burst of data and the second burst of data at the memory system 110. Further, the memory system 110 may deactivate a second data strobe signal of the set during the duration of the first data strobe and after the first burst of data is received. Deactivating the second data strobe signal may allow the memory system to reset a DFE function for a first write bit of the second burst of data.

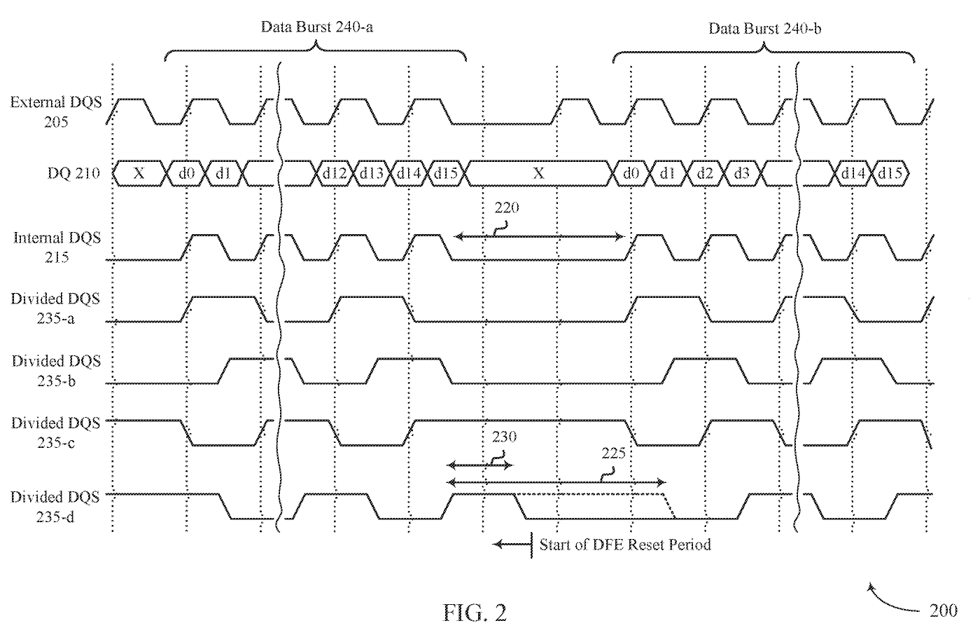

FIG. 2 shows an example of a signal timing diagram 200 that supports increased DFE accuracy based on divided data strobe control in accordance with examples as disclosed herein. In some examples, aspects of the signal timing diagram 200 may be implemented by aspects of a system 100. For example, aspects of the signal timing diagram 200 may be implemented by aspects of the memory system 110 as described in FIG. 1.

In some examples, a memory system may receive write commands (e.g., from a host system) that instruct the memory system to write data to the memory system. During a write command, the memory system may receive a burst of data 240 via a data line (e.g., DQ 210). For example, as shown in FIG. 2, for each write command, the memory system may receive a burst of data 240 that includes unit intervals d0 through d15 (or write bits d0 through d15). Additionally, the memory system may receive a data strobe signal that specifies when to latch each data segment of the burst of data 240. For example, the memory system may receive external data strobe signal 205. As shown in FIG. 2, the external data strobe signal 205 may indicate to latch at both rising and falling edges. A rising edge may refer to an increase in voltage from a LOW state to a HIGH state and may be correspond to a single unit interval, whereas a falling edge may refer to a decrease in voltage from the HIGH state to the LOW state and may be correspond to a single unit interval.

In some examples, to reduce speed and complexity at the memory system, the memory system may divide an internal data strobe signal 215 (e.g., the received external data strobe signal 205) into multiple phase-shifted data strobe signals. For example, as shown in FIG. 2, the memory system may divide the internal data strobe signal 215 into a divided data strobe signal 235-a, a divided data strobe signal 235-b, a divided data strobe signal 235-c, and a divided data strobe signal 235-d. The divided data strobe signal 235-a, the divided data strobe signal 235-b, the divided data strobe signal 235-c, and the divided data strobe signal 235-d may be phase-shifted from the internal data strobe signal 215 by 0 degrees, 90 degrees, 180 degrees, and 270 degrees, respectively.

Each divided data strobe signal 235 may indicate to latch a respective data segment of the burst of data 240 at each rising edge of the divided data strobe signal 235. For example, the divided data strobe signal 235-a may indicate to latch d0, d4, d8, and d12 at different rising edges of the divided data strobe signal 235-a. In some examples, transitioning the divided data strobe signal from the LOW state to the HIGH state may be referred to as activating the divided data strobe signal 235. Alternatively, transitioning the divided data strobe signal 235 from the HIGH state to the LOW state may be referred to as deactivating the divided data strobe signal 235.

In some examples, the memory system may receive multiple consecutive write commands. For example, the memory system may receive a first write command to write a burst of data 240-a to the memory system and a second write command to write a burst of data 240-b to the memory system. In some examples, there may be a duration 220 between the burst of data 240-a for the first write command and the burst of data 240-b for the second write command. During at least a portion of the duration 220, the internal data strobe signal 215 may not toggle (e.g., may remain in the deactivated or LOW state and may not indicate to latch any data segment received via the DQ 210).

To facilitate communications, the data strobe signal may include a preamble and a postamble. In some memory systems (e.g., DDR5), a preamble (e.g., a read preamble or a write preamble) may be a specific period before the data burst during which the data bus transitions from a high impedance state to an active state. This period may be used to prepare the bus for the incoming data burst and to ensure that the receiving circuitry is correctly synchronized with the data transmission. Similarly, in some memory systems (e.g., DDR5), a postamble (e.g., a read preamble or a write preamble) may be a specific period after the data burst during which the data bus returns to a high impedance state. This period allows for the termination of the operation (e.g., a read operation or a write operation) and prepares the bus for the next operation.

It may take one or more unit intervals for a data strobe signal to be synced in time correctly. Thus, preamble may be sent to ensure that timings of the data strobe signal are synced before sending a burst of data associated with the data strobe signal. Similarly, a postamble may ensure that data strobe signal stays synced through the entire burst of data and is prepared for the next operation. Further, during at least a portion of the duration 220, the memory system may receive a postamble for the first write command and a preamble for the second write.

Some data bursts may be scheduled close enough together that a preamble of one data burst may overlap with a postamble of another data burst. Such situations may result in errors if not handled. In some cases, a memory system may use interambles between data bursts that are particular close together in time. In some examples, the postamble may overlap at least partially with the preamble resulting in an interamble. In some examples, the duration 220 may be greater than one clock cycle (e.g., tCCD = Min+1, tCCD=Min+2, tCCD=Min+3, tCCD=Min+4, or tCCD=Min+5).

Because the internal data strobe signal 215 may not toggle during the duration 220, the divided data strobe signal 235-d may remain in the activated state (e.g., in a HIGH state) for an extended period of time. For example, as shown in FIG. 2, the divided data strobe signal 235-d may remain in the activated state for a duration 225. Further, as shown in FIG. 2, the divided data strobe signal 235-d may remain activate even after the divided data strobe signal 235-a indicates to latch the first data segment (or a first write bit) of the burst of data 240-b (e.g., d0 of the burst of data 240-b).

In some examples, the memory system may support a DFE function. The DFE function may help the memory system mitigate inter-symbol interference (ISI). To do this, the DFE function may utilize a signal of one or more previous unit intervals (e.g., Tap1, Tap2, Tap3, or Tap4) to control the gain of current data segment (e.g., current write data bit). For example, the DFE function may utilize at least the signal of d14 of the burst of data 240-a to control the gain of d15 of the burst of data 240-a. Thus, to control the gain of d0 of the burst of data 240-b, the DFE function may utilize the signal of d15 of the burst of data 240-a because the divided data strobe signal 235-d is active prior to or during gain control of d0 of the burst of data 240-b. However, the signal of d15 of the burst of data 240-a may not be an accurate representation of the current state of the data line (or DQ 210) resulting in inaccurate gain control and ISI (e.g., in the context of an interamble where the data strobe signal stays active but the data signal is floating or held at a certain voltage for a time).

In some examples, if the memory system identifies that a divided data strobe signal 235 has not been active for some time before gain control of a current data segment is performed, the DFE function for gain control of the current data segment may reset. The methods as described herein propose deactivating a divided data strobe signal 235 indicating latching of a last write bit of a burst of data 240 prior to gain control of a first write bit of a subsequent burst of data 240 such that DFE is reset thereby increasing accuracy of the gain control and ISI mitigation of the first write bit of the subsequent burst of data 240.

In some examples, the memory system may include a deactivation component that is coupled with the divided data strobe signal 235 that controls the latching of the last write bit of the burst of data 240-a (e.g., the divided data strobe signal 235-d). The deactivation component may be configured to deactivate the divided data strobe signal 235-d prior to the end of the duration 225. For example, the deactivation component may deactivate the divided data strobe signal 235-d a duration 230 after indicating to latch the last write bit (e.g., d15) of the burst of data 240-a. The end of the duration 230 or the deactivation of the divided data strobe signal 235-d may fall within the DFE reset period.

That is, deactivation of the divided data strobe signal 235-d at the end of the duration 230 may trigger the memory system to perform a DFE reset for gain control of the first write bit of the burst of data 240-b. The start of the DFE reset period may mark a minimum time that the divided data strobe signal 235-d may be deactivated such that DFE function for the first write bit of the burst of data 240-b is reset. Using the methods as described herein may allow the memory system to reset a DFE function for a first write burst of a data burst during consecutive write commands such that the memory system does not utilize stale signal information for gain control of the first write bit.

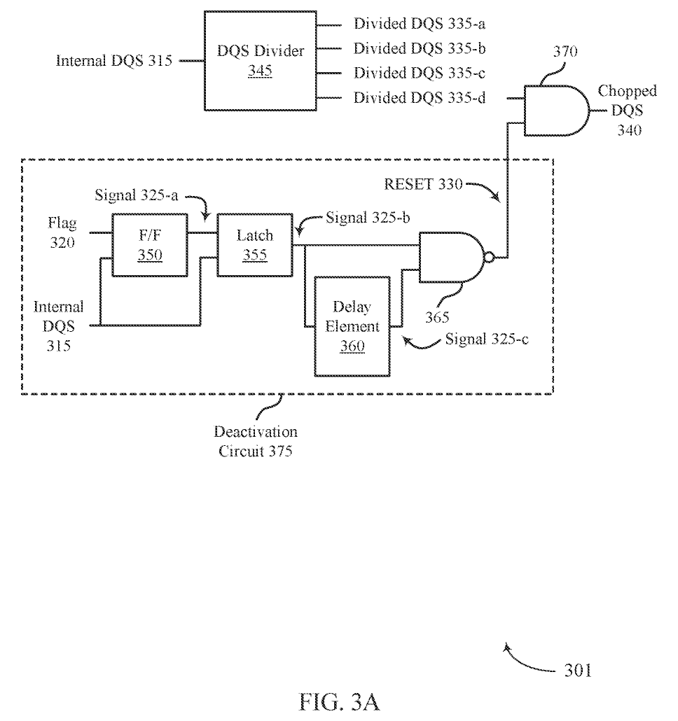

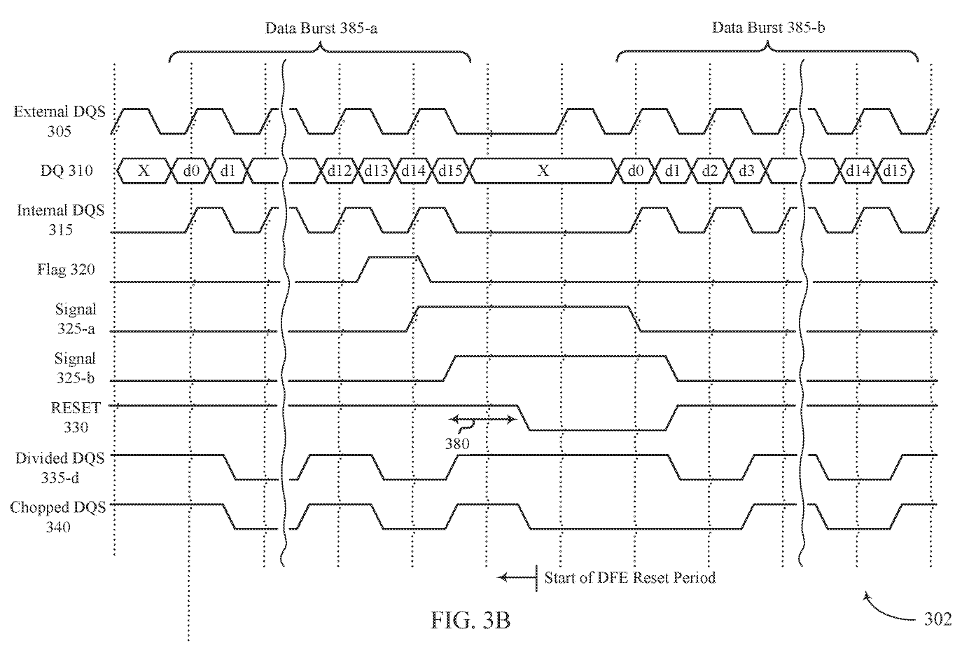

FIG. 3A shows an example of a system 301 that supports increased DFE accuracy based on divided data strobe control in accordance with examples as disclosed herein. In some examples, the system 301 may be an example of a memory system 110 as described with reference to FIG. 1.

FIG. 3B illustrates an example of a signal timing diagram 302 that supports increased DFE accuracy based on divided data strobe control in accordance with examples as disclosed herein. In some examples, aspects of the signal timing diagram 302 may be implemented by aspects of a system 100. For example, aspects of the signal timing diagram 302 may be implemented by aspects of the memory system 110. Further, aspects of the signal timing diagram 302 may implement aspects of the signal timing diagram 200. For example, an external data strobe signal 305, an internal data strobe signal 315, and divided data strobe signals 335 may be examples of the external data strobe signal 205, the internal data strobe signal 215, and the divided data strobe signals 235, respectively, as described with reference to FIG. 2.

In some examples, the system 301 may include a data strobe signal divider 345. The data strobe signal divider 345 may be configured to divide an internal data strobe signal 315 (e.g., an external data strobe signal 305 received by the system 301 from a host system) into multiple data strobe signals that are phase-shifted with respect to one another. For example, the data strobe signal divider 345 may divide the internal data strobe signal 315 into a divided data strobe signal 335-a, a divided data strobe signal 335-b, a divided data strobe signal 335-c, and a divided data strobe signal 335-d. As shown in FIG. 3A, at least one divided data strobe signal 335 (e.g., divided data strobe signal 335-d) may be routed to a first input node of a logic gate 370 (e.g., AND gate).

In addition to the data strobe signal divider 345, the system 301 may include a deactivation circuit 375. The deactivation circuit 375 may include multiple components configured to deactivate one of the divided data strobe signals 335. In some examples, the deactivation circuit 375 may include a flip-flop circuit 350, a latch 355, a delay element 360, and a logic gate 365 (e.g., a NAND gate). As shown in FIG. 3A, a first input node of the flip-flop circuit 350 may be coupled with a flag signal line of the memory system (e.g., a signal line configured to carry a flag 320) and a second input node of the flip-flop circuit 350 may be coupled with an internal data strobe signal line of the memory system (e.g., a signal line configured to carry the internal data strobe signal 315).

Additionally or alternatively, an output node of the flip-flop circuit 350 may be coupled with a first input node of a latch 355 and the internal data strobe signal line may be coupled with a second input node of the latch 355. Additionally or alternatively, an output node of the latch 355 may be coupled with an input node of the delay element 360 and a first input node of the logic gate 365. Additionally or alternatively, the output node of the delay element 360 may be coupled with the second input node of the logic gate 365. Further, the output node of the logic gate 365 may be coupled with a second input node of a logic gate 370.

In some examples, the system 300 may receive multiple consecutive write commands. For example, the system 300 may receive a first write command followed by a second write command. The first write command may indicate to write a burst of data 385-a to memory of the system 300 and the second write command may indicate to write a burst of data 380-b to the memory. Each burst of data may include multiple unit intervals or write bits (e.g., d0 through d15) and may be received via DQ 310. Further, each divided data strobe signal 335 may indicate to latch one or more respective unit intervals of a respective burst of data 385. For example, the divided data strobe signal 335-d may indicate when to latch the last write bit or d15 of the burst of data 385-a.

In some examples, as a part of the first write command, the flip-flop circuit 350 may receive the flag 320. In some examples, receiving the flag 320 may include updating a voltage of the first input node of the flip-flop circuit 350 from a deactivated state (e.g., a LOW state) to an activated state (e.g., a HIGH state). The flag 320 may indicate that the first write command is ending. Further, in some examples, the flip-flop circuit 350 may receive the flag 320 prior to the indication to latch the last write bit of the first write command (e.g., d15 of the burst of data 385-a). For example, as shown in FIG. 3B, the flip-flop circuit 350 may receive the flag 320 after the indication to latch d12 and prior to the indication to latch d13. In some examples, the first input node of the flip-flop circuit 350 may remain in the activated state for a duration (e.g., until just before the latching of last write bit of the first write command).

In addition, the flip-flop circuit 350 may receive the internal data strobe signal 315. In some examples, after receiving the flag 320 and while the first input of the flip-flop circuit 350 is in the activated state (e.g., the HIGH state), the internal data strobe signal 315 may transition from the deactivated state (e.g., the LOW state) to the activated state (e.g., the HIGH state) indicating to latch a second to last write bit of the first write command (e.g., d14). This may cause both input nodes of the flip-flop circuit 350 to be in the activated state during a same time.

As a result, the flip-flop circuit 350 may activate a signal 325-a (e.g., increase a voltage of the signal 325-a) causing the first input node of the latch 355 to transition from the deactivated state (e.g., the LOW state) to the activated state (e.g., the HIGH state). While the first node of the latch 355 is in the activated state (e.g., the HIGH state), the internal data strobe signal 315 may transition from the activated state (e.g., the HIGH state) to the deactivated state (e.g., the LOW state) indicating to latch the last write bit of the first write command (e.g., d15). This may cause the first input of the latch 355 to be in the activated state while the second input of the latch 355 is in a deactivated state. Further, during this time, the divided data strobe signal 335-b may transition from the deactivated state (e.g., the LOW state) to the activated state (e.g., the HIGH state), indicating to latch the last write bit of the first write command (e.g., d15).

As a result, the latch 355 may activate a signal 325-b. This may cause the first input of the logic gate 365 to be in an activated state (e.g., the HIGH state). In some examples, the delay element 360 may receive the signal 325-b and delay activation of the signal 325-c for a duration 380. After the duration 380, the delay element may activate the signal 325-c causing the second input node of the logic gate 365 to be in the activated state (e.g., the HIGH state). Thus, both the first input node and the second input node of the logic gate 365 may be in the activated state after the duration 380.

As a result, the output node of the logic gate may deactivate a RESET signal 330 output from the logic gate 365 causing the state of the second input node of the logic gate 370 to transition from the activated state to the deactivated state. While the second input node of the logic gate 370 is in the deactivated state (e.g., the LOW state), the divided data strobe signal 335-d fed into the first input of the logic gate 370 may be in the activated state (e.g., due to latching of the last write data bit of the burst of data 385-a) causing the logic gate 370 to deactivate the divided data strobe signal 335-d (e.g., transition the divided data strobe signal 335-d) resulting in a chopped data strobe signal 340.

Thus, using the methods as described herein, the deactivation circuit 375 may deactivate the divided data strobe signal 335-d the duration 380 after indicating to latch a last write data bit of the first write command. The end of the duration 380 may occur during a DFE reset period. As a result, the memory system may reset the DFE function for gain control of the first write bit of the second write command resulting in more accurate ISI mitigation.

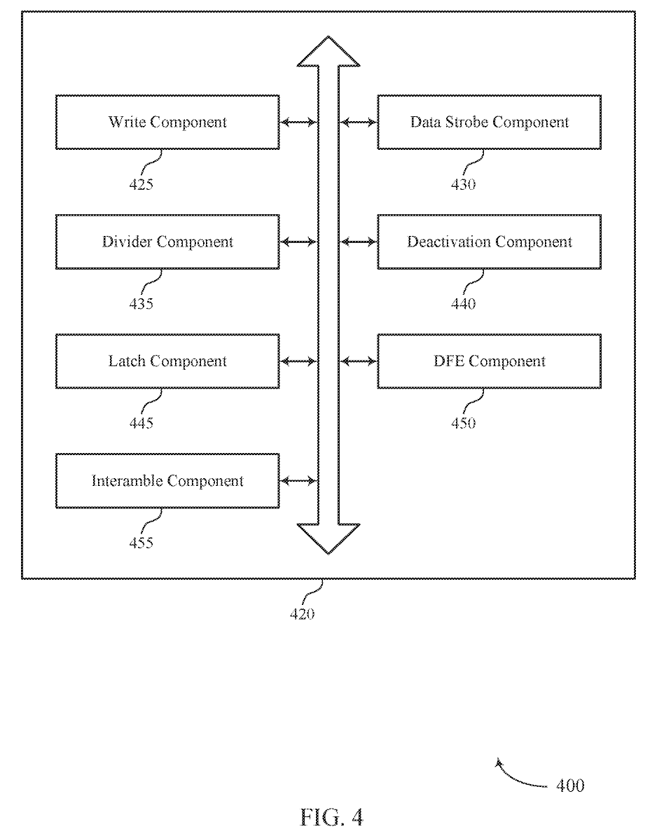

FIG. 4 shows a block diagram 400 of a memory system 420 that supports increased DFE accuracy based on divided data strobe control in accordance with examples as disclosed herein. The memory system 420 may be an example of aspects of a memory system as described with reference to FIGS. 1, 2, 3A, and 3B. The memory system 420, or various components thereof, may be an example of means for performing various aspects of increased DFE accuracy based on divided data strobe control as described herein. For example, the memory system 420 may include a write component 425, a data strobe component 430, a divider component 435, a deactivation component 440, a latch component 445, a DFE component 450, an interamble component 455, or any combination thereof. Each of these components, or components of subcomponents thereof (e.g., one or more processors, one or more memories), may communicate, directly or indirectly, with one another (e.g., via one or more buses).

The write component 425 may be configured as or otherwise support a means for receiving a first write command to write a first burst of data to the memory system and a second write command to write a second burst of data to the memory system. The data strobe component 430 may be configured as or otherwise support a means for receiving a first data strobe signal associated with the first write command and the second write command, the first data strobe signal having a duration between communication of the first burst of data and communication of the second burst of data. The divider component 435 may be configured as or otherwise support a means for generating a plurality of second data strobe signals that are phase-shifted relative to each other based at least in part on the first data strobe signal, where the plurality of second data strobe signals are used to latch the first burst of data and the second burst of data at the memory system. The deactivation component 440 may be configured as or otherwise support a means for deactivating a second data strobe signal of the plurality of second data strobe signals during the duration of the first data strobe signal and after the first burst of data is received.

In some examples, to support deactivating the second data strobe signal of the plurality of second data strobe signals during the duration, the deactivation component 440 may be configured as or otherwise support a means for deactivating the second data strobe signal of the plurality of second data strobe signals prior to latching a first write bit of the second burst of data.

In some examples, to support deactivating the second data strobe signal of the plurality of second data strobe signals during the duration, the deactivation component 440 may be configured as or otherwise support a means for deactivating the second data strobe signal of the plurality of second data strobe signals after latching a last bit of the first burst of data.

In some examples, the latch component 445 may be configured as or otherwise support a means for discarding a last write bit of the first burst of data prior to an end of the duration based on deactivating the second data strobe signal of the plurality of second data strobe signals.

In some examples, the DFE component 450 may be configured as or otherwise support a means for resetting a DFE functionality of the memory system for gain control of a first write bit of the second burst of data based at least in part on deactivating the second data strobe signal.

In some examples, to support deactivating the second data strobe signal, the deactivation component 440 may be configured as or otherwise support a means for adjusting a voltage supplied to a signal line carrying the second data strobe signal of the plurality of second data strobe signals.

In some examples, the interamble component 455 may be configured as or otherwise support a means for receiving, during the duration, a postamble for the first burst of data and a preamble for the second burst of data, where the postamble at least partially overlaps the preamble. In some examples, the duration is greater than one clock cycle.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

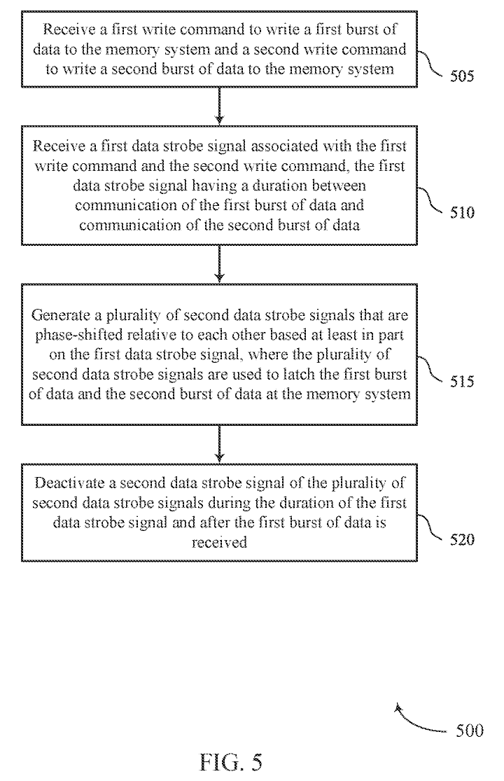

FIG. 5 shows a flowchart illustrating a method 500 that supports increased DFE accuracy based on divided data strobe control in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first write command to write a first burst of data to the memory system and a second write command to write a second burst of data to the memory system. In some examples, aspects of the operations of 505 may be performed by a write component 425 as described with reference to FIG. 4.

At 510, the method may include receiving a first data strobe signal associated with the first write command and the second write command, the first data strobe signal having a duration between communication of the first burst of data and communication of the second burst of data. In some examples, aspects of the operations of 510 may be performed by a data strobe component 430 as described with reference to FIG. 4.

At 515, the method may include generating a plurality of second data strobe signals that are phase-shifted relative to each other based at least in part on the first data strobe signal, where the plurality of second data strobe signals are used to latch the first burst of data and the second burst of data at the memory system. In some examples, aspects of the operations of 515 may be performed by a divider component 435 as described with reference to FIG. 4.

At 520, the method may include deactivating a second data strobe signal of the plurality of second data strobe signals during the duration of the first data strobe signal and after the first burst of data is received. In some examples, aspects of the operations of 520 may be performed by a deactivation component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first write command to write a first burst of data to the memory system and a second write command to write a second burst of data to the memory system; receiving a first data strobe signal associated with the first write command and the second write command, the first data strobe signal having a duration between communication of the first burst of data and communication of the second burst of data; generating a plurality of second data strobe signals that are phase-shifted relative to each other based at least in part on the first data strobe signal, where the plurality of second data strobe signals are used to latch the first burst of data and the second burst of data at the memory system; and deactivating a second data strobe signal of the plurality of second data strobe signals during the duration of the first data strobe signal and after the first burst of data is received.

Aspect 2: The method, apparatus, or non-transitory computer-readable medium of aspect 1, where deactivating the second data strobe signal of the plurality of second data strobe signals during the duration includes operations, features, circuitry, logic, means, or instructions, or any combination thereof for deactivating the second data strobe signal of the plurality of second data strobe signals prior to latching a first write bit of the second burst of data.

Aspect 3: The method, apparatus, or non-transitory computer-readable medium of any of aspects 1 through 2, where deactivating the second data strobe signal of the plurality of second data strobe signals during the duration includes operations, features, circuitry, logic, means, or instructions, or any combination thereof for deactivating the second data strobe signal of the plurality of second data strobe signals after latching a last bit of the first burst of data.

Aspect 4: The method, apparatus, or non-transitory computer-readable medium of any of aspects 1 through 3, further including operations, features, circuitry, logic, means, or instructions, or any combination thereof for discarding a last write bit of the first burst of data prior to an end of the duration based on deactivating the second data strobe signal of the plurality of second data strobe signals.

Aspect 5: The method, apparatus, or non-transitory computer-readable medium of any of aspects 1 through 4, further including operations, features, circuitry, logic, means, or instructions, or any combination thereof for resetting a DFE functionality of the memory system for gain control of a first write bit of the second burst of data based at least in part on deactivating the second data strobe signal.

Aspect 6: The method, apparatus, or non-transitory computer-readable medium of any of aspects 1 through 5, where deactivating the second data strobe signal includes operations, features, circuitry, logic, means, or instructions, or any combination thereof for adjusting a voltage supplied to a signal line carrying the second data strobe signal of the plurality of second data strobe signals.

Aspect 7: The method, apparatus, or non-transitory computer-readable medium of any of aspects 1 through 6, further including operations, features, circuitry, logic, means, or instructions, or any combination thereof for receiving, during the duration, a postamble for the first burst of data and a preamble for the second burst of data, where the postamble at least partially overlaps the preamble.

Aspect 8: The method, apparatus, or non-transitory computer-readable medium of any of aspects 1 through 7, where the duration is greater than one clock cycle.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first write command to write a first burst of data to the memory system and a second write command to write a second burst of data to the memory system;
receive a first data strobe signal associated with the first write command and the second write command, the first data strobe signal having a duration between communication of the first burst of data and communication of the second burst of data;
generate a plurality of second data strobe signals that are phase-shifted relative to each other based at least in part on the first data strobe signal, wherein the plurality of second data strobe signals are used to latch the first burst of data and the second burst of data at the memory system; and
deactivate a second data strobe signal of the plurality of second data strobe signals during the duration of the first data strobe signal and after the first burst of data is received.

2. The memory system of claim 1, wherein, to deactivate the second data strobe signal of the plurality of second data strobe signals during the duration, the processing circuitry is configured to cause the memory system to:
deactivate the second data strobe signal of the plurality of second data strobe signals prior to latching a first write bit of the second burst of data.

3. The memory system of claim 1, wherein, to deactivate the second data strobe signal of the plurality of second data strobe signals during the duration, the processing circuitry is configured to cause the memory system to:
deactivate the second data strobe signal of the plurality of second data strobe signals after latching a last bit of the first burst of data.

4. The memory system of claim 1, wherein the processing circuitry is configured to cause the memory system to:
discard a last write bit of the first burst of data prior to an end of the duration based on deactivating the second data strobe signal of the plurality of second data strobe signals.

5. The memory system of claim 1, wherein the processing circuitry is configured to cause the memory system to:
reset a decision feedback equalization functionality of the memory system for gain control of a first write bit of the second burst of data based at least in part on deactivating the second data strobe signal.

6. The memory system of claim 1, wherein, to deactivate the second data strobe signal, the processing circuitry is configured to cause the memory system to:
adjust a voltage supplied to a signal line carrying the second data strobe signal of the plurality of second data strobe signals.

7. The memory system of claim 1, wherein the processing circuitry is configured to cause the memory system to:
receive, during the duration, a postamble for the first burst of data and a preamble for the second burst of data, wherein the postamble at least partially overlaps the preamble.

8. The memory system of claim 1, wherein:
the duration is greater than one clock cycle.

9. A method by a memory system, comprising:
receiving a first write command to write a first burst of data to the memory system and a second write command to write a second burst of data to the memory system;
receiving a first data strobe signal associated with the first write command and the second write command, the first data strobe signal having a duration between communication of the first burst of data and communication of the second burst of data;
generating a plurality of second data strobe signals that are phase-shifted relative to each other based at least in part on the first data strobe signal, wherein the plurality of second data strobe signals are used to latch the first burst of data and the second burst of data at the memory system; and
deactivating a second data strobe signal of the plurality of second data strobe signals during the duration of the first data strobe signal and after the first burst of data is received.

10. The method of claim 9, wherein deactivating the second data strobe signal of the plurality of second data strobe signals during the duration comprises:
deactivating the second data strobe signal of the plurality of second data strobe signals prior to latching a first write bit of the second burst of data.

11. The method of claim 9, wherein deactivating the second data strobe signal of the plurality of second data strobe signals during the duration comprises:
deactivating the second data strobe signal of the plurality of second data strobe signals after latching a last bit of the first burst of data.

12. The method of claim 9, further comprising:
discarding a last write bit of the first burst of data prior to an end of the duration based on deactivating the second data strobe signal of the plurality of second data strobe signals.

13. The method of claim 9, further comprising:
resetting a decision feedback equalization functionality of the memory system for gain control of a first write bit of the second burst of data based at least in part on deactivating the second data strobe signal.

14. The method of claim 9, wherein deactivating the second data strobe signal comprises:
adjusting a voltage supplied to a signal line carrying the second data strobe signal of the plurality of second data strobe signals.

15. The method of claim 9, further comprising:
receiving, during the duration, a postamble for the first burst of data and a preamble for the second burst of data, wherein the postamble at least partially overlaps the preamble.

16. The method of claim 9, wherein the duration is greater than one clock cycle.

17. A non-transitory computer-readable medium storing code, the code comprising instructions executable by one or more processors to:
receive a first write command to write a first burst of data to a memory system and a second write command to write a second burst of data to the memory system;
receive a first data strobe signal associated with the first write command and the second write command, the first data strobe signal having a duration between communication of the first burst of data and communication of the second burst of data;
generate a plurality of second data strobe signals that are phase-shifted relative to each other based at least in part on the first data strobe signal, wherein the plurality of second data strobe signals are used to latch the first burst of data and the second burst of data at the memory system; and
deactivate a second data strobe signal of the plurality of second data strobe signals during the duration of the first data strobe signal and after the first burst of data is received.

18. The non-transitory computer-readable medium of claim 17, wherein the instructions to deactivate the second data strobe signal of the plurality of second data strobe signals during the duration are executable by the one or more processors to:
deactivate the second data strobe signal of the plurality of second data strobe signals prior to latching a first write bit of the second burst of data.

19. The non-transitory computer-readable medium of claim 17, wherein the instructions to deactivate the second data strobe signal of the plurality of second data strobe signals during the duration are executable by the one or more processors to:
deactivate the second data strobe signal of the plurality of second data strobe signals after latching a last bit of the first burst of data.

20. The non-transitory computer-readable medium of claim 17, wherein the instructions are further executable by the one or more processors to:
discard a last write bit of the first burst of data prior to an end of the duration based on deactivating the second data strobe signal of the plurality of second data strobe signals.
